(19) United States
(12) Patent Application Publication
(10) Pub. No.: US 2010/0094704 A1
(43) Pub. Date: Apr. 15, 2010

(54) METHOD AND SYSTEM FOR DISPLAYING INTERNET AD MEDIA USING ETAGS

(75) Inventors: Anand Subramanian, New York, NY (US); Dave C. Peterson, New York, NY (US); Paul L. George, New York, NY (US)

Correspondence Address: DARBY & DARBY P.C., P.O. BOX 770, Church Street Station, New York, NY, 10008-0770, US

(73) Assignee: CONTEXTWEB, INC., New York, NY (US)

(21) Appl. No.: 12/580,040

(22) Filed: Oct. 15, 2009

Related U.S. Application Data
(60) Provisional application No. 61/105,644, filed on Oct. 15, 2008.

(51) Int. Cl. G06Q 30/00

(52) U.S. Cl. 705/14.45; 705/14.49; 705/14.41

(57) ABSTRACT

Presented are embodiments of a system and method that tracks user actions associated with a displayed advertisement, absent of cookie technology. The system may generate an ETag in response to a user action, such as an ad click, and transmit the ad media to the user. The system may then determine whether other actions performed by the user resulted from the advertisement.

### CROSS REFERENCE TO RELATED APPLICATION

The present application claims the benefit under 35 U.S.C. §119(e) of U.S. Provisional Patent Application No. 61/105,644, entitled “New Method and System for Displaying Internet Ad Media Using ETags,” filed on Oct. 15, 2008, which is incorporated by reference herein in its entirety.

### FIELD OF THE INVENTION

The present invention relates to a method and system that will monitor the delivery of identified advertising campaigns using entity tags (ETags). An ETag (entity tag) is a hypertext transfer protocol (HTTP) response header returned by an HTTP/1.1 compliant web server used to determine change in content at a given uniform resource locator (URL). The method disclosed herein can be used for auto recognition of repeat visitors to website. In related aspects of the inventive ETag method, the method can revolutionize website analytics. The ETag method can enable the tracking of user patterns as well as traffic patterns for a website. The inventive method relates to a computer-implemented system supporting a browser that can be run from any browser-capable device, including, but not limited to: a personal digital assistant (PDA), a mobile telephone, a notebook computer, a desktop computer, and the like.

### BACKGROUND OF THE INVENTION

This invention relates generally to computer software and systems, and more particularly to methods for serving advertising via a network, such as the Internet, without the use of cookie technology.

The World Wide Web (“web”, “Internet”, or “online”) is becoming ubiquitous. Millions of people now access the Internet on a daily basis to shop for goods and services and obtain information of interest. For example, suppose an individual wants to purchase a camera via the Internet. The individual accesses the Internet and types in a vendor's URL. The individual may then access that vendor's home page to determine whether the vendor has the product that this individual wishes to purchase. If the individual does not know which vendors sell cameras, the individual may access a web site associated with a search engine. The individual enters the generic term “camera” into the search engine to attempt to locate a vendor that sells cameras. Using a search engine in this manner to locate individual web sites that offer the desired product or service often results in a list of hundreds or even thousands of search results. The search results are a list of “hits” where each hit may correspond to a web page that relates to the search term.

In addition, the search engine may provide companies' advertisements relating to the product or service to which the individual is interested. For the example above, the search engine may provide advertisements for cameras. The search engine may charge companies a predetermined fee each time the companies' advertisements are displayed to a user of the search engine. A more recent trend is to charge companies a fee each time their advertisement is selected by a user (i.e. each time a user clicks on the displayed advertisement).

Advertisers, however, are aware that not all clicks on their advertisements result in desired user actions or “conversions.” A conversion may be defined by the advertiser and may represent a purchase, a registration, a page-view, etc. Advertisers, therefore, like to know the conversion rate associated with their advertisements being displayed to users. This allows the advertiser to maximize their return on investment (ROI) by reducing fees paid on non-profitable advertisements.

Conversion tracking may also be useful for search engine companies. If a search company was able to accurately track conversions, the search engine company may be able to vary the way in which companies are charged for targeted ads.

Cookies can be used for tracking conversions associated with user actions. Cookies are short pieces of data used by web servers to help identify web users. Cookies can be used any platform that can use a modern web browser. They do not do damage to files or systems. Cookies are only used to identify a web user though they may be used to track a user's browsing habits.

If a user is concerned about being identified or about having his web browsing traced through the use of a cookie, his browser can be set to not accept cookies. Alternatively, the user can employ a cookie blocking program or choose to use a browser that automatically blocks cookies or at least third party cookies. Note that blocking all cookies prevents some online services from working. Also, preventing a browser from accepting cookies does not make one an anonymous user, it just makes it more difficult to track usage. Third party advertisement serving on the Internet arose as a method for advertisers to use third parties to deploy web-based advertising and to measure and validate the quantity and quality of advertisements served by a web site. Existing “cookie” technology was adapted in order to enable accurate measurement of the number of unique web page views and click-throughs. Cookies are small text files created and subsequently read by browsers, such as Internet Explorer, Netscape Navigator, Firefox, and Safari. The browser sends an existing cookie along with a web page request to a web server. If a cookie does not already exist on the web browser, the web server can use a browser's cookie facility to set a cookie and store data therein. A web server might store information, such as access date, domain name, customer type, and activity type.

If a browser views a web page served by a web server that uses cookies, one or more cookies are set to the browser's local repository. Because of the design of the underlying web server/browser technology, when the browser returns to the previously viewed web page at some future time, the web server that originally set the cookie automatically retrieves a copy of the cookie and can then modify it and send it back to the web browser. Additionally, if a cookie was originally set by a web server, the server's domain is granted future access to the cookie even if the browser does not return to the original web server. Alternatively, cookies can be set and retrieved from within the browser via documents and script retrieved from the web server's domain. The cookies contents are shared between the browser and the server, each able to exchange information with the other.

As an illustrative example, suppose an advertiser's web site is visited by a web browser, “Browser A.” The advertiser is a company called “Company Name,” and the company has its own domain, web server, and web site. The domain of Company Name is “.companyname.com.” When Browser A views the Company Name web site, the advertiser's web server web server sets an cookie to Browser A. Browser A then leaves the Company Name web site and visits other web sites, including a web page on a publisher site, “http://website2.com.” Generally, a publisher web site is one that presents one or more different types of content and offers advertisement or banner space therewith. An advertiser can “rent” the banner space from the publisher and can serve advertisements directly from its own web server, or it can arrange to have a third-party company, an “adserver,” serve the advertising. In this example, the advertiser has arranged for an adserver to serve the advertising for the web site. Thus, the publisher's web site, “www.website2.com,” contains a banner ad that is served by the adserver. The adserver has its own domain, for example, “.adserver.com.” If Browser A is configured to accept third-party cookies, the adserver's web server can set a cookie to Browser A.

Whenever a browser has a cookie that is associated with a particular domain, it will send the cookie to the web server within the domain along with any request for web content from the web server. In other words, once a web server has set a cookie on a browser, the browser will send the cookie to the web server unless the browser is specifically set to block the cookie. When a web server receives a cookie, it is available to be written into log files on the server. Even if a web server is set to ignore incoming cookies and take no action based on their content, it still receives the cookies and can log them. Thus, both adservers' and advertisers' web servers have difficulties avoiding their own cookies.

There are two additional facets to web page, web server, and cookie technologies that should be understood. First, the web site listed in a browsers URL address bar may not be serving the entire web page that the browser is displaying. Instead, the various components that make up the web page can be served by different web servers. An individual user could point a web browser to a publisher's web page, for example, that has a frame across the bottom in which an adserver displays an advertisement. Both the publisher's web server and the adserver's web server may set cookies to the user's browser (unless the user has enabled third party cookie blocking). Second, cookies set to a particular web server domain are available to be read by any web server in the domain or sub-domain thereof. For example, Company has a web server “Alpha” that serves a web page from the domain “.company.com” and sets cookie “A” to a particular computer user's browser. When the user subsequently directs his browser to a web page served from the domain “.server2.company.com,” a second company web server “Beta” serves the second web page. Since the web server Beta has a domain under the domain of web server Alpha (web server Beta's domain is called a sub-domain of web server Alpha's domain), each time the web server Beta receives a web page request, it will receive any cookie previously written to the requesting browser by the web server Alpha.

Delivering an advertisement to a browser through an adserver that uses cookies to serve, track, and measure the advertisements that were purchased has advantages. Advertisers use adservers because of the features and benefits they provide, including: counting and measurement of ad performance regardless of the web site on which the advertising appears; independent verification of advertising views and click-throughs; and web-wide, site agnostic implementation, reporting, and measurement of all web-based advertising. However, downsides to using an adserver include the following: third party cookies of the adserver can be blocked by a user or may even be deleted by anti-spyware programs, advertising data gained from adserver cookies is not readily available to the advertiser, the advertiser has to wait until it receives data (e.g., log file data) from the adserver, or the adserver has to build a real-time cookie synchronization process. The reverse is also true; the adserver has to wait to receive log file data from the advertiser or build a real-time cookie synchronization process before the adserver can target advertisements based on customer variables (e.g., customer=high value) that were recently changed by the advertiser. Additionally, a disadvantage of many current cookie synchronization processes is that they are unidirectional as opposed to shared cookie implementation in which data can be shared bi-directionally.

Although much cookie usage can be relatively harmless, some uses can raise serious privacy concerns since web servers can use cookies to recognize and track web viewing habits of a particular browser. Because data concerning web viewing habits can be valuable, a person's browsing history can be a commodity that is bought and sold. The privacy concerns thus raised by cookie usage have created a backlash among the Internet using populace, causing many users to disable or otherwise limit the cookie features of their browsers. By limiting cookie technologies, browsers are unable to view and access the full content and features of the cookie-enabled web sites.

This backlash against cookie use has caused the advertising industry to feel increasing pressure in some situations to avoid cookie technologies. However, the industry still desires to continue enjoying the efficiencies and benefits of using adservers without the added burden of customer's privacy being intruded upon. Furthermore, because many adservers have created cookies in the past, even if they stop using cookies now, they would still receive and cannot avoid reading any previously created cookies along with any new web pages requests. There is therefore a need, in these situations, for a solution that avoids cookie technologies while still allowing advertisers to use adservers and reap the benefits thereof.

The solution can be found in the use of ETags. Cookies and ETags have the same granularity and ability of tracking users and machines. However, an ETag is machine specific and user specific while cookies are only user specific. For instance, two users with separate logins on the same computer will have separate independent cookies and separate independent caches, and as a result, separate independent ETags. Therefore, an ETag is more accurate as a measurement. U.S. Patent Publication No. 2008/0320225 (Panzer, et al.), which is incorporated by reference herein in its entirety, discloses a method for caching and serving content to different types of users based on ETags. U.S. Patent Publication No. 2009/0144395 (DeSalvo), which is incorporated by reference herein in its entirety, discloses a method employing ETags to compare a latest content version on a server with a current content version on a data processing device requesting the content, and to request the content from the server only when ETag information for the current content version fails to match ETag information for the latest version.

### SUMMARY OF THE INVENTION

The invention applies to a system and method that enables advertisers to use adservers without relying on cookie technology. The invention also holds true for publishers to create personalize features adapted to returning users without cookie technology. It is also applicable in the ecommerce space for creating shopping cart solutions. In all cases this solution solves many of the restrictions on cookie technology as well (e.g. browser limits on the number and size of cookies).

By providing interactive, adaptive, and automated filling of ad media without relying on cookie technology, this invention has immediate application in advertising, publishing, and ecommerce space of the Internet at all levels. Implementations described and claimed herein address the foregoing problems by providing adservers with the ability to analyze user habits, thereby circumventing cookie blocking programs and anti-cookie browsers. Further, advertising cookie data can be gathered regardless of whether a user is browsing a publisher's web site with an advertisement served by an adserver, or browsing the advertiser's web site, because the cookies can be monitored when the user visited the advertiser's web site. By making cookies and advertising data immediately available in real time to both the advertiser and the adserver, the solution also provides for instantaneous and accurate targeting of web advertising to allow an educated ad selection process by either party. Other implementations are also described and recited herein.

Implementations presented herein are consistent with the principles of the invention of detecting whether particular user actions are performed.

In accordance with the principles of the invention, an implementation provided is a method for tracking user actions.

In another implementation consistent with the principles of the invention, a method for tracking multiple individual users of a common shared computer through individual operating system or browser profiles.

In another implementation consistent with the principles of the invention, a server includes a memory and a processor. The processor may be configured to receive at least one ETag in response to a user action, where the ETag is associated with an advertiser. The processor may also be configured to store the at least one ETag in the memory and receive a conversion indication associated with the advertiser. The processor may further be configured to determine whether the conversion resulted from an advertisement associated with the advertiser based at least in part on the stored ETag. The ETag can also associate information about the environment that the user saw the ad in (e.g. placement, category, how many times ad viewed, etc.). It also can contain information relating to the set of all ads that this advertiser has shown to the user.

In a further implementation consistent with the principles of the invention, a method for enabling tracking of users' actions is provided. The method may include identifying a user action and generating an ETag in response to the user action, where the ETag is associated with the advertiser or publisher. The method may also include transmitting the ETag to the user and receiving the ETag from the user in response to another action by the user. The method may include providing a conversion tracking option to an advertiser and receiving a selection from the advertiser. The selection may indicate that the advertiser wishes to enable tracking of users' actions for at least one account associated with the advertiser. The method may further include enabling tracking for the at least one account.

In still another implementation consistent with the principles of the invention, a method for tracking user actions is provided. The method may include providing an ad to a user. The method may also include receiving an ad click associated with the ad, generating an ETag in response to the ad click and transmitting the ETag to the user. The method may further include receiving information in response to a user action, where the information indicates that the user performed a conversion associated with an advertiser, and determining whether the conversion resulted from the ad.

In another implementation consistent with the principles of the invention, a method that may include selecting an ad associated with an advertiser and receiving an ETag in response to the selection is provided. The method may also include performing a conversion associated with the advertiser and determining whether an identifier associated with the ETag matches an identifier on a web page associated with the conversion. The method may further include transmitting the ETag when the identifiers match.

In another implementation consistent with the principles of the invention, a method that may include frequency capping of ad creative units. Information on how many times individual users have seen a creative unit can be stored and retrieved from the ETag and thereby limit overexposing users to the same unit avoiding creative burnout.

In another implementation consistent with the principles of the invention, a method that may include the sequencing of ad creative units. Information on which ads in a creative unit sequence can be stored in the ETag allow advertisers to select a sequencing of offers to the user based upon what the user has already seen.

In another implementation consistent with the principles of the invention, a method that may include expanding unique user reach of the advertiser. By tracking who has already seen creative units in the ETag, another implementation consistent with the principles of the invention can create unique exposure opportunities by not showing the creative units to those users who have already been exposed to it. This can be across the entire Internet space and not just within a single advertising network by distributing the ETag technology principles of the invention along with the creative unit so that exposures are tracked everywhere that the ad runs.

In another implementation consistent with the principles of the invention, a method that may include ecommerce shopping carts. The ETag can be utilized in ecommerce shopping cart situations where cookies are not available so that items in the users shopping cart are persisted from session to session. Again without size or number limitations inherent in cookie technology.

In another implementation consistent with the principles of the invention, a method that may include personalized messaging for returning users to publisher site or site section tailored to previous user actions.

In another implementation consistent with the principles of the invention, a method that may include unlimited number of ETags not restricted to browser cookie limits.

In another implementation consistent with the principles of the invention, a method that may include unlimited size of ETags not restricted to browser cookie limits.

### BRIEF DESCRIPTION OF THE DRAWINGS

For a better understanding of the nature, objects, and processes involved in this invention, reference should be made to the detailed description taken in conjunction with the accompanying drawing.

FIG. 1 is a flow chart illustrating an example of activity of processing the request for the advertiser banner;

### DESCRIPTION OF THE INVENTION

A cookie is a short piece of data, not code, which is sent from a web server to a web browser or visa versa when that browser visits the server's site. The cookie is stored on the user's machine, but it is not an executable program and cannot do anything to your machine. Whenever a web browser requests a file from the web server that sent it and cookie, the browser sends a copy of that cookie back to the server along with the request. Thus a server sends you and cookie and you send it back whenever you request another file from the same server. In this way, the server knows you have visited before and can coordinate your access to different pages on its web site. For example, an Internet shopping site uses a cookie to keep track of which shopping basket belongs to you. A server cannot find out your name or e-mail address, or anything about your computer using cookies.

Normally, cookies are only sent back to the server that originally sent them to the browser and to no one else. A server can set the domain attribute for a cookie so that any server in the same Internet sub-domain as the computer that sent the cookie will have the cookie sent along with a file request. This is so those larger sites that utilize multiple servers can coordinate their cookies across all the servers. The domain path can not be set to send cookies to a sub-domain outside of the sub-domain where the server resides.

A cookie is sent to a browser by including a line with the following syntax in the header of an HTML document. Note that the header is removed from the document before the browser displays it. Thus, you will not see the header lines if you execute the View, Source or View, Document Source commands in your browser.

Set-Cookie: NAME=VALUE; expires=DATE; path=PATH; domain=DOMAIN_NAME; secure

Here the upper case names are strings the server can set.

NAME=VALUE is the name of the cookie and it's VALUE. This is the data that the web server wants passed back to it when a browser requests another page.

DATE is an attribute that determines how long the cookie persists on your system. If there is no expiration date, the cookie is stored in memory only and expires at the end of the current session (that is, when you quit the web browser). If the DATE attribute is in the future, the cookie is a persistent cookie and is saved in a file. Only persistent cookies can be used to track a user at more than one site. Setting the date for an existing cookie to be some day in the past deletes the cookie.

DOMAIN_NAME is an attribute that contains the address of the server that sent the cookie and that will receive a copy of this cookie when the browser requests a file from that server. It defaults to the server that set the cookie if it is not explicitly set in the Set-Cookie: line. DOMAIN_NAME may be set to equal the sub-domain that contains the server so that multiple servers in the same sub-domain will receive the cookie from the browser. This allows larger web sites to coordinate multiple servers in the same sub-domain. For example, if the DOMAIN_NAME equals www.mydomain.com then machines named one.www.mydomain.com, two.www.mydomain.com, and three.www.mydomain.com would all receive the cookie from the browser. The value of DOMAIN_NAME is limited such that only hosts within the indicated sub-domain may set a cookie for that sub-domain and the sub-domain name is required to contain at least two or three dots in it. Two dots are required if the top level domain is: .COM, .EDU, .NET, .ORG, .GOV, .MIL, or .INT. Three dots are required for any other domain. This is to prevent the sub-domain from being set to something like .COM, the sub-domain of all commercial machines.

PATH is an attribute that is used to further refine when a cookie is sent back to a server. When the PATH attribute is set, a cookie is only sent back to the server if both the DOMAIN_NAME and the PATH match for the requested file secure is an attribute that specifies that the cookie is only sent if a secure channel (https) is being used.

A server can get information get from a browser. When a browser sends a request to a server, it includes its IP address, the type of browser being are used, and the operating system of the user's computer. This information is usually logged in the server's log file. A cookie sent along with the request can add only that information, which is contained in the cookie and which, was originally sent to the browser by the same server. Thus, there is no additional personal information explicitly sent to the server by allowing cookies.

Cookies are used by Internet shopping sites to keep track of the user and what's in the user's shopping cart. When the user first visits an Internet shopping site, the user is sent a cookie containing the name (ID number) of a shopping cart. Each time the user selects an item to purchase, that item is added to the shopping cart. When the user is done with shopping, the checkout page lists all the items in the shopping cart tied to that cookie. Without cookies, the user would have to keep track of all the items intended to be purchased and type them into the checkout page or buy each item, one at a time.

Another method is for the shopping site to send a separate cookie containing the item number to the user's browser whenever the user selects an item to purchase. The user's browser sends all those cookies along with the request for the checkout page. The checkout page uses the cookies to make a list of the items intended to be purchased.

Another use of cookies is to create customized home pages. A cookie is sent to the user's browser for each of the items the user expects to see on the user's custom home page. Whenever the user requests his custom home page the user's cookies are sent along with the request to tell the server which items to display. Without cookies, a server would require the user to identify himself each time the user visit the custom page so it knows what items to display. The server would also have to store the custom page settings for every visitor.

One of the less admirable uses of cookies, and the one that is causing all the controversy, is its use as a device for tracking the browsing and buying habits of individual web users. On a single web site or a group of web sites within a single sub-domain, cookies can be used to see what web pages the user visits and how often the user visits them. This information is also in the server's log files and so the use of a cookie here does not increase a server's ability to track the user, it just makes it easier.

On multiple client sites being serviced by a single marketing site, cookies can be used to track the user's browsing habits on all the client sites. The way this works is a marketing firm contracts with multiple client sites to display its advertising. The client sites simply put an <IMG> tag on their web pages to display the image containing the marketing firm's advertisement. The tag does not point to an image file on the client's machine but contains the URL of the marketing firm's advertisement server and includes the URL of the client's page. Thus when the user opens a page on the client's site the advertisement the user sees was actually obtained from the advertising firm's site.

The advertising firm sends a cookie along with the advertisement, and that cookie is sent back to the advertising firm the next time the user views any page containing one if its advertisements. If many web sites support the same advertising firm, that firm will be able to track the user's browsing habits from page to page within all the client sites. They will not be able to see what the user does with the pages the user view; they will only know which pages the user is viewing, how often the user views them, and the IP address of the user's computer. This information can be used to infer the things the user is interested in and to target advertising to the user based on those inferences.

The user can prevent any cookies from being sent to the user's system using the browser options. In Internet Explorer 4.0, choose the View, Internet Options command, click the advanced tab and click the Disable All Cookie Use option. In Netscape 4.0, choose the Edit, Options command, click on Advanced and click the Disable Cookies option. After that, no cookies will be stored on the user's system. The user will need to turn cookies back on if the user want to use any online services that require them. The user can also choose the option to prompt him before accepting a cookie, but at many sites the user will be continually closing the warning dialog box.

If the user's browser is an earlier version of Netscape or Internet Explorer, the user can require that the browser warn him before accepting a cookie, but it cannot block all cookies. At a busy shopping site, acknowledging all the warnings can get really tedious.

Several companies are offering special software packages that work with the user's web browser to control who can send the user a cookie. In these packages, the user designates which sites can send him a cookie and which can not, alleviating the need to turn cookie use on and off by hand.

Some browser will allow first party cookies, but by default block all third parties. Safari browser is an example of this.

Programs written in VBScript, JavaScript, and Java that are attached to a web page can read and store cookies on the user's system. The limitations on these cookies are the same as cookies sent to the user's browser by the server that sent him the program. Cookies created by these programs can only pass information from one page to the next.

A first party advertisement serving environment in which an adserver shares a domain of an advertiser is provided. Since the adserver shares the advertiser's domain, the adserver has first party access to cookies set by the advertiser and can thus read and write to the advertiser's cookie data set on a user's browser. Even if the user has blocked the use of third party cookies via his browser security settings, the adserver can read and write to first party cookies of the advertiser without being blocked by the security settings. Further, such first party cookies of an advertiser are less likely to be considered spyware and blocked or deleted by an anti-spyware program. Thus, the adserver operating within the domain of the advertiser can provide advertisement services that might not be available to a third party adserver.

In one implementation of the present invention, for example, an advertiser provides access to one of its sub-domains to an adserver. The adserver can then serve web pages and components of web pages (for example, advertisements) from the sub-domain to which it was granted access by the advertiser. Thus, an ETag originally written by a web server of the advertiser is available to be read and written to by a web server of the adserver. A computer user who modifies browser options in order to block the setting of third party ETags will not block the reading of ETags by a sub-domain because the ETags were set in the first party context on the advertiser's site.

In another implementation, the environment includes a web browser, an advertiser web site having an associated domain and web server, a first party ETag, a publisher web site, and an adserver serving advertisements into the publisher web site. When the browser accesses the advertiser web site, the associated web server sets the first party ETag to the browser. At some time later, when the browser accesses the publisher web site that contains advertisements served by the adserver, the browser sends the advertiser's ETag to the adserver and requests an advertisement. The adserver receives ETags because the adserver's domain is a sub-domain of the advertiser's domain. The adserver reads the ETag and based on the ETag value sends the requested content back to the browser.

In yet another implementation, the use and deployment of web servers and ETag technology is structured so that the advertiser's Customer Relationship Management (CRM) system can fully utilize the real time data gathered and shared by both the advertiser and the adservers through shared ETags. Because both the advertiser and the adserver read and write to the same ETags, data can be shared in real-time. Delays caused by current methods of periodically synchronizing adserver and advertiser data (e.g., overnight ETag synchronization) are eliminated or at least reduced.

In one implementation, the adserver that is serving web advertising from within an advertiser domain is not limited to serving advertisements depicting the primary advertiser. Instead, the adserver can serve advertisements from one or more other companies (or fourth parties). If the fourth parties have pre-existing relationships with the advertiser (e.g., marketing partnerships, cross-selling agreements, joint ventures, etc.) both the advertiser and fourth parties can reap the extra benefits of having the fourth party advertisements be served from within a sub-domain of the advertiser.

Take for example, a system showing first party advertisement serving. In this implementation, a user operates a web browser that includes one or more ETags. The web browser may be resident on any digital media addressable device, such as but not limited to a personal computer, a laptop computer, a handheld device (e.g., a cell phone, an MP3 player, a blackberry, a personal data assistant), or the like. The user directs the browser to a web site, such as “www.website.com,” via the browser. The web site is served by a publisher, which is responsible for the overall content of the web site.

There are various methods by which an advertiser can provide sub-domain access to an adserver. In one implementation, for example, the advertiser uses its domain name service (DNS) servers to delegate or redirect sub-domain DNS requests to adserver DNS servers. This process is called DNS delegation. This can be accomplished by creating Name Server (NS) records in the advertiser DNS servers that point to the adserver DNS server. In another implementation, the advertiser can point their host name to the adserver's Internet Protocol (IP) address by means of an Address Record (or “A Record”) in the advertiser DNS servers. In yet another implementation, the adserver's hardware and software are co-located within the advertiser's infrastructure or co-located on the same network as the advertiser's infrastructure.

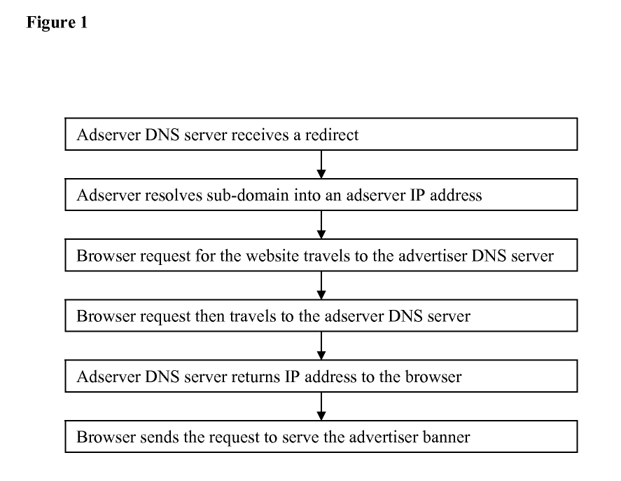

An associated process is illustrated in FIG. 1. When an adserver DNS server receives a redirect, it takes the logical name of a sub-domain sent from the advertiser DNS server (e.g., “ads.companyname.com”) and resolves it into an adserver IP address. For example, “ads.companyname.com” would be resolved into an IP address, such as “216.150.209.230.” A browser request for the web site “ads.companyname.com” travels to the advertiser DNS server and then to the adserver DNS server. The adserver DNS server would return the IP address “216.150.209.230” to the browser. After receiving the associated IP address, the browser sends the request to serve the advertiser banner.

The adserver receives the request to serve the advertiser banner and determines an advertisement for displaying in the banner. The adserver, for example, may determine an appropriate content for the advertising banner depending upon at least one value of an ETag received from the browser. When the adserver receives and reads an ETag accompanying a browser request, for example, the adserver may recognize ETag values identified for advertisement selection that the advertiser's web server originally placed in the ETag. For example, if an advertiser's web server recognizes that a particular customer who is visiting the advertiser's web site is a high value customer. The web server then sets an ETag to the customer's browser containing the domain “.advertiser.com” and the data “Target=high_value.” The advertiser previously communicated with an adserver to convey the rule that whenever the adserver encounters ETag data with “Target=high_value,” the adserver should recognize that it is dealing with a high value customer of the advertiser and should serve advertising appropriate to such a customer. Each time the customer visits the “www.advertiser.com” web site, the “Target” ETag value can be reset by the advertiser's web server to reflect the customer's current value status. For instance, the customer may be a “medium value” customer when he first accesses the advertiser's web site, but then makes a large purchase. The advertiser's web server can update the customer's status to “high_value” and then reset the ETag information accordingly. If the customer's browser subsequently interacts with the adserver's web server, the updated ETag value will instantaneously cause a “high_value” advertisement to be returned from the adserver's web server to the customer's browser.

While the adserver is serving web advertising from within the domain of the advertiser, the adserver may not be not limited to serving advertisements on behalf of the primary advertiser. Instead, the adserver can serve advertisements from one or more other companies (or fourth parties). If the fourth parties have pre-existing relationships with the advertiser (e.g., marketing partnerships, cross-selling agreements, joint ventures, etc.) both the advertiser and fourth parties can reap the extra benefits of having the fourth party advertisements be served from within a sub-domain of the advertiser.

If the user clicks on or otherwise selects the advertisement in the banner, the user's browser is directed to a web site of the advertiser, which is located within the advertiser's domain “advertiser.com.”

Continuing the above example, a user directs his web browser to the “http://home.lender.com” web site. He then completes a “Request Loan” web form and the Lender web server sets an ETag on his browser containing the completed information. Lender, the advertiser, enters into an arrangement with Adserver to serve banner advertisements on publisher web sites “publisher1.com” and “publisher2.com.” Lender and Adserver configure their servers and DNS servers according to an implementation described above. Adserver has a domain of “ads.lender.com” that is a sub-domain of the advertiser Lender's domain “lender.com.” Later the user directs his browser to the publisher's web site “publisher1.com” that includes a banner advertisement for Lender that is served by Adserver. Because the user's browser already contains an ETag for the domain lender.com created earlier by the lender web server, the ETag is sent by the browser to the Adserver web server along with a request for the banner advertisement. The Adserver web server reads the ETag and recognizes that the customer has a pending loan application. In response, the Adserver web server sends “Banner 1” advertisement back to the web browser.

Later the same day, the user visits “lender.com” again and this time selects a rate of 4%. This information is added to the “lender.com” ETag by the Lender web server. The user directs his browser to the second publisher web site “publisher2.com,” which also contains a Lender banner advertisement. The browser sends the lender.com ETag to the Adserver web server requesting the banner advertisement. The Adserver web server reads the ETag and recognizes that the rate or 4% as set by the Lender web server earlier. In response, the Adserver web server sends “Banner 4” back to the web browser.

In one particular implementation, the adserver may also support secure socket layer (SSL) protocol (e.g., HTTPS://) to at least one of the advertisers. By sharing the logical domain of the advertiser, the adserver can use a certificate of the advertiser to enable SSL communication. The advertiser, for example, may purchase an SSL certificate for the sub-domain “ads.advertiser.com” and supply the adserver with the certificate to match the sub-domain delegated to the adserver and the parent domain of the advertiser.

Here's another example of operations behind a method of serving an advertisement. A user directs a browser to a web site hosted by a publisher and including a component such as a banner advertisement served by an adserver in operation. The user may, for example, enter a uniform resource locator (URL) or an Internet Protocol address in the browser to direct the browser to a desired web site. The web site includes a link to the publisher for retrieving content for the web site and a link to the adserver to retrieve an advertisement for a component of the web site, such as a banner advertisement. When the browser accesses the web site, the browser sends a content request to the publisher via the link from the web site for content in operation. The publisher responds to the content request by providing content for the web site to the browser in operation.

The browser also sends an advertisement serving request directed to a sub-domain of an advertiser via the link to request advertising content in operation. The request is routed to a DNS server of a parent domain of the advertiser in operation. The DNS server redirects the advertisement serving request to a DNS server of the sub-domain that is associated with the adserver serving the banner advertisement of the web site in operation. As described above, infrastructure associated with the sub-domain may be co-located with infrastructure of the parent domain of the advertiser, may be co-located on a private network, may be accessible via a public network (e.g., the Internet), or the like.

The advertisement serving request may be redirected by a DNS server of the parent domain of the advertiser in a number of ways. In one implementation, for example, DNS delegation is used in which a name server (NS) record in the DNS server points to a DNS server of the adserver. In this manner, the advertisement serving request directed to the sub-domain is received by the DNS server of the advertiser and forwarded to the adserver via an NS record that points to a DNS server of the adserver. In this implementation, the sub-domain “ads.advertiser.com” would be assigned to the adserver, which would assign IP addresses of its system to the name “ads.”

In another implementation, the DNS server of the parent domain of the advertiser utilizes an Address Record (“A Record”) in the parent domain DNS server to point to an address of a server of the adserver, such as pointing directly to an Internet Protocol (IP) address of the server. Other implementations are also contemplated.

If the browser includes a copy of one or more ETag associated with a domain of the advertiser (e.g., the parent domain, the sub-domain, or another domain of the advertiser), the one or more ETag is forwarded to the adserver in operation. The one or more ETag may be forwarded to the adserver along with the advertisement service request or may be forwarded to the adserver separately from the advertisement service request. The adserver may read and write to the ETag as a first party directly associated with the ETag because the adserver shares the domain of the advertiser. Thus, the one or more ETag on the browser may be updated directly by either the advertiser or the adserver without having to synchronize information between the advertiser and the adserver.

The adserver receives the advertisement serving request from the publisher web site in operation. The adserver, for example, may receive the advertisement serving request at a DNS server of the adserver after it has been redirected, such as described above with respect to operation. The adserver DNS server, in turn, resolves the sub-domain into an address (e.g., an IP address) and forwards the advertisement serving request to a server associated with the address. In another implementation, a server of the adserver may receive the advertisement serving request directly from the DNS server of the advertiser via an address record (A Record) of the advertiser DNS server.

If one or more ETag associated with the parent domain of the advertiser is forwarded from the browser, the adserver also receives the one or more ETag in operation. As described above the one or more ETag may be received together with the advertisement service request or may be received separately from the advertisement service request.

The adserver receives the advertisement serving request and the one or more ETag (if applicable) and selects an advertisement from a plurality of advertisements. The adserver, for example, may select the advertisement based at least in part upon an ETag associated with the parent domain of the advertiser. If no ETag is transmitted, however, the adserver may select the advertisement according to other criteria. As described above, the adserver may select an advertisement associated with the advertiser or may select an advertisement on behalf of another party (i.e., a fourth party). The fourth party, for example, may have a cross-marketing agreement in place with the advertiser or may simply be another party unrelated to the advertiser.

The adserver then forwards content for the selected advertisement to the browser in operation. In one implementation, for example, the content is forwarded directly from the adserver to the browser via an open socket.

In a further implementation consistent with the principles of the invention, below is an example of a method for enabling tracking of users' actions. The method includes providing a conversion tracking option to an advertiser and receiving a selection from the advertiser.

Conversion tracker may include a front end, an ad mixer and a log processing module. Front end acts as the front end of conversion tracker to receive information associated with conversion tracking, such as ad click information, and generate ETags, as described in more detail below. For example, front end may set and parse hypertext transfer protocol (HTTP) ETags associated with tracking user actions. Ad mixer may receive ad click information and return information regarding the ad click to front end. Log processing module may analyze ad click and conversion information and generate reports based on this information. It should also be understood that in alternative implementations, the functions performed by processing device may be performed by another processing device. Further, in alternative implementations, a single processing device may perform the functions of conversion tracker.

As an example of processing to enabling conversion tracking in an implementation consistent with the principles of the invention, the following description focuses on one or more servers that provide searching functions and paid advertisements. It will be appreciated that the techniques described herein are equally applicable to any server(s) that may provide advertisements for which fees are charged when the advertisements are selected by or presented to a user of a client device, and indeed to any system in which particular user actions are to be determined. For example, the techniques described herein are applicable to identifying user actions with respect to traditional banner advertisements, advertisements targeted based on the content or concepts in a document or page being provided to users, etc.

Processing may begin by an advertiser accessing server. For example, advertiser may connect to server via network by entering a uniform resource locator (URL) in a browser being executed by advertiser. Alternatively, an entity associated with advertiser may connect to server via a processing device/computer executing a conventional web browser. Server may provide a user interface (UI) that includes a selection for advertisers that purchase advertising related to key words that may be input to the search engine executed by server. For example, as discussed above, advertiser may represent an existing advertiser who has purchased one or more words/terms associated with computer queries/searches. Purchasing these words/terms may enable advertiser to be featured when a search query entered by a user includes those words/terms. For example, advertiser may be featured by an ad (whether in the form of a banner ad, text ad, pop-up or pop-under window, etc.) on a web page displayed to a client.

Assume that advertiser clicks on (i.e., selects) the advertiser option. Server may then provide a UI that includes a button/box that may be clicked or selected to enable conversion tracking for that advertiser. The conversion tracking option may allow an advertiser to individually enable conversion tracking for each account that the particular advertiser controls. For example, advertiser may control multiple accounts. In this case, advertiser may wish to enable conversion tracking for one or more of the accounts. Assume that advertiser has a single account and enables conversion tracking for that account. When conversion tracking is enabled, server will be able to track conversion rates with respect to ad clicks, ad impressions and other information, as described in more detail below. The term “ad impression” as used herein generally refers to the display of an advertisement to a client.

After conversion tracking is enabled, server may generate a conversion tracking identifier (ID) associated with each account that has been selected for conversion tracking. The particular conversion tracking ID may be unique for each particular account. In the example above in which advertiser enabled conversion tracking for a single account, server may generate a single conversion tracking ID. In some implementations, the conversion tracking ID may correspond to advertiser's account ID. This conversion tracking ID enables server to maintain privacy with respect to clients. For example, in implementations consistent with the principles of the invention, the conversion tracking ID is included in an ETag path associated with tracking ad clicks, as described in more detail below. This may limit the number of ETags being transmitted, thereby reducing privacy concerns associated with some users. In other implementations, a single conversion tracking ID may be used for all advertisers that have enabled conversion tracking or no conversion tracking ID may be used.

Note that the conversion tracking ID may not affect the level of granularity at which reports may be generated. For example, even if a single conversion tracking ID was used for all advertisers in the system, server may still associate the ad click data with specific advertisers, campaigns, creatives, etc. This is because the ETags may include additional information regarding the ad clicks, such as advertiser specific information.

After conversion tracking is enabled and a conversion tracking ID has been assigned, server generates a snippet, e.g., a piece of software code that may be provided to advertiser. In an exemplary implementation consistent with the present invention, the snippet may be a piece of hypertext markup language/JavaScript (HTML/JS) code that allows clients and/or advertiser to pass information to server, such as the value of a conversion, a label describing the type of conversion (e.g., a purchase, a registration, a page view, a download, etc.), the environment that the ad was seen in (e.g. publisher page, page content, etc.) to be associated with a conversion, after a conversion has occurred. This allows for optimizing the campaign to create a higher level conversion or click rate. In an exemplary implementation consistent with the present invention, the snippet may be an image request that is transmitted to server after a conversion has occurred. An example of such an HTML snippet may be as follows:

<imgsrc=“http://www.contextwebadservices.com/pagead/conversion/GHS

n- x87543x/conversion?value=123&label=“Purchase”&format120x60>

In this example, “contextwebadservices.com” represents server and GHSnx87543x represents the conversion tracking ID assigned to the conversion tracking enabled account associated with advertiser. The conversion tracking ID included in the snippet may be used to determine whether client will send an ETag to server after a conversion occurs, as described in more detail below. “Value” and “label” may represent optional parameters that can be dynamically generated and appended to the HTML image request. The value parameter may represent an advertiser defined unit or value associated with a conversion specified in any units (e.g., dollars). If a particular advertiser has the same unit or value for each conversion, server may include the actual unit/value in the snippet. For example, if each conversion is worth $10 to advertiser, the value field may specify the value of ten dollars. The label parameter may be a free form text label that can be assigned to differentiate types of conversions that may be used in a final report (e.g., “purchase,” “registration,” “mailing list signup,” “page view,” “download,” etc.). The set of available labels may be predefined and any requests not included within the predefined list may be marked as an UnknownLabelType. The label parameter may also be set dynamically, per page, to advertiser specific custom labels. The format parameter defines the size of the post conversion page image that will be returned to advertiser when a conversion is achieved, as described in more detail below.

Server may also provide a Javascript (JS) wrapper and instructions to an advertiser that facilitates setting the value and label parameters and pasting the snippet into the appropriate page. For example, server may provide a number of snippets that may be pasted into a number of advertiser pages. The JS wrapper may facilitate setting the values and labels in each snippet based on the particular item/product associated with the conversion. For example, if advertiser sells only three products having prices of $50, $100 and $200, server may provide three snippets and advertiser may set the value in each snippet to the values $50, $100 and $200, respectively. Alternatively, server may set the values in each snippet and also include the appropriate label for each snippet.

After server provides advertiser with the HTML/JS snippet(s), along with instructions associated with the snippet, advertiser may paste the snippet(s) in the appropriate post conversion page(s) on advertiser's web site. As described previously, each advertiser may define what acts are considered conversions. When a client performs such a predefined act, a conversion has taken place. For example, a purchase, a registration, a page view, a sign-up, a download, etc., may be considered a conversion. In each case, a post-conversion page provided by advertiser may be displayed to client. For example, in the case of a purchase, advertiser may provide a web page to client after client has transmitted a credit card number to advertiser for purchasing a particular product. When advertiser receives the credit card information, the purchase has been completed and advertiser may provide a page that states “Your purchase has been completed. Your total charges are X. Such a page may represent a post-conversion page.

After advertiser pastes the HTML/JS snippet(s) into the appropriate post conversion page(s), conversion tracking is enabled for advertiser. The process for conversion tracking may then commence in a manner that is transparent with respect to advertiser.

The processing described below uses the example of conversion tracking associated with ads based on search queries. However, as discussed above, the techniques described herein may be used in any system in which particular user actions are to be determined/identified. Processing may begin with a client accessing server via network and receiving a UI for entering a search query. Assume that the user enters a search query and transmits the search query to server. Server receives the search query, executes the search and generates a list of search results.

Server may also identify advertiser(s) based on the search query. For example, server may store advertiser information in a memory, such as storage device. The advertiser information may include a database of key words and corresponding advertisers (along with their URLs) who have purchased advertising associated with the key words. When server receives a query, server searches the advertiser information to determine whether any advertiser has purchased advertising associated with one or more terms in the input query. Server may then identify the advertiser(s) associated with the input query and the particular web site(s) associated with the respective advertiser(s). In one implementation, server may also generate a redirect URL for each identified advertiser that has enabled conversion tracking so that the URL points to server. For example, server may generate a redirect URL associated with a conversion tracking enabled advertiser, such as:

http://www.contextwebadservices.com/pagead/adclick?
adurl=http://www.advertiser.com/landingpage&sa=1

This redirect URL may point to contextwebadservices.com, which in this example, corresponds to server, and may indicate that the redirect is associated with an ad click on a page ad. The redirect URL may also point to the advertiser's landing page or home page (i.e., advertiser.com/landingpage). The presence of sa=1 in the exemplary URL above may be used by log processing module to recognize this URL is associated with an ad click. Other information may also be included in the redirect URL.

After generating the redirect URL(s) for each conversion tracking enabled advertiser associated with the search query, server transmits the search results and advertisement(s) to client for display. Assume that a user, via client, performs an ad click on an ad associated with a conversion tracking enabled advertiser displayed on client. For example, assume that a web site associated with advertiser is provided on the web page displayed on client and that advertiser has enabled conversion tracking. Further assume that the user, via client, clicks on the displayed ad associated with advertiser.

After client selects the ad associated with advertiser, an ad click request is sent to server as a result of the redirect URL generated at act. For example, server may receive an ad click HTTP request, such as:

http://www.contextwebadservices.com/pagead/adclick?
url=http://www.advertiser.com/landingpage&sa=1

As discussed above, the redirect URL points to contextwebadservices.com, which in this example, corresponds to server. Conversion tracker in server receives the ad click request and directs client to advertiser's home page or landing page, which in this example may be http://www.advertiser.com/landing page. In an exemplary implementation, front end may also store or log the ad click request and forward the ad click request to ad mixer. In some implementations consistent with the present invention, front end may also redirect the request back to itself by, for example, rewriting sa=1 to sa=L. This may ensure that clicks by web crawlers are not counted in the number of ad clicks associated with an advertiser. For example, automated crawling software that does not follow HTTP redirects will never make a request for the URL where the field sa=1 has been rewritten to sa=L. This prevents spamming by automated crawlers that lack this redirect following feature.

Ad mixer receives the ad click request and may log the ad click request along with information contained within the ETag about the environment that the user was exposed to the ad. Ad mixer and/or front end, may also analyze the ad click request to determine whether an ETag should be generated in response to the ad click. For example, ETags may be set for conversion tracking enabled advertisers. In the example above, since conversion tracking is enabled for advertiser, ad mixer and/or front end may determine that an ETag should be set. Ad mixer may also identify the conversion tracking ID associated with advertiser, which will be included in the ETag path. In an exemplary implementation consistent with present invention, including the conversion tracking ID in the ETag path limits the number of ETags that will be sent to server, as described in more detail below.

Ad mixer may further identify the approximate time that the ad click occurred and generate an ad click time stamp (TS). The TS may be a globally unique identifier that includes the time that ad mixer received the ad click request. The TS may also include other information, such as server IP address/host processor ID, etc., to ensure that the TS is globally unique. Ad mixer may then generate a message including the TS, a conversion tracking ID and a Boolean indicating whether an ETag should be set. If the ad click was not associated with a conversion tracking enabled advertiser, the Boolean will indicate that no ETag should be generated. Ad mixer may forward this message to front end.

Front end receives the message from ad mixer and determines whether an ETag is to be set. The ETag may represent a conversion tracking ETag associated with tracking conversions for an advertiser. Assume that the information from ad mixer indicates that an ETag is to be set, front end may then generate the conversion tracking ETag. In an exemplary implementation, the conversion tracking ETag may also include a click string (CS). The CS may represent the particular ad click(s) or action(s) performed by the user and may be used to track the user's actions. The conversion tracking ETag may also include the ad click TS and/or an expiration date associated with the ETag. The conversion tracking ETag's path may also include the conversion tracking ID of the conversion tracking enabled advertiser. Front end may send the ETag to client along with the redirect URL pointing to advertiser's site. For example, server may send an HTTP message to client that includes the following information:

Set-ETag: CONVERSION=CS=A6yIzdSDw-4-

iX8pj0IqkRPRxTzfA1Kp6FA5xKXgA-
CApTBAsmMEABCgpF:TS=1055812564745609;

path=/pagead/conversion/GHSnx87543/;

domain=.contextwebadservices.com

In the example above, the message indicates that an ETag identified as CONVERSION is to be set and that the ETag includes a CS. The message however, does not have an expiration date since ETags do not support dates like cookies do. ETags have to be manually deleted when expired.

The exemplary message above also includes a path for the ETag and a domain. The domain, contextwebadservices.com, corresponds to server in this example. The ETag path in the example above is: pagead/conversion/GHSnx87543/. The field GHSnx87543 in the ETag path may represent the conversion tracking ID for advertiser. By including the conversion tracking ID in the ETag path, this ETag will not be forwarded to server when ad clicks associated with other advertisers are performed. For example, in one implementation consistent with the present invention, client will only send an ETag associated with a particular advertiser when client performs what that particular conversion tracking enabled advertiser pre-defined to be a conversion, as described in more detail below. When client clicks on impressions or performs conversions not associated with advertisers that have not enabled conversion tracking, no ETags will be sent by client. Reducing the number of times ETags are sent reduces the ability of server to track user actions. This may reduce privacy concerns of privacy sensitive users. In other implementations consistent with the present invention in which privacy concerns are not as great, client may send ETags associated with conversion tracking enabled advertisers when no conversions for those advertisers have occurred. In this manner, server may identify more actions performed by users.

Client receives the message indicating that the ETag is to be set and redirect URL from server. Client may store the ETag and use the redirect URL to access advertiser's web site. Thereafter, additional user actions (e.g., conversions) associated with advertiser may be transmitted to server via the ETag.

Assume that client performs an act defined by advertiser to be a conversion for that particular advertiser. In this case, when client performs the conversion, advertiser downloads a post conversion page to client. As discussed above, the post conversion page includes the snippet (i.e., the HTML image request) provided to advertiser. As further discussed above, in one implementation, the snippet may include an image request. Advertiser downloads the post conversion page to client. When client receives and displays the post conversion page, client executes the snippet. The snippet, as described previously, may include a conversion tracking ID associated with advertiser. When the snippet is executed, client sends the image request to server. That is, client executes the snippet and sends a post conversion image request to server. For example, the post conversion HTTP image request may include the following information:

http://www.contextwebadservices.com/pagead/conversion/GHSnx87543x/

?valu- e=123&label=Purchase&format=120x60.

This image request includes information indicating that a conversion occurred, the conversion tracking ID, a value, a label and a format for the image.

Client may also compare the conversion tracking ID included in the snippet (GHSnx87543x in this example) with the conversion tracking ID in the stored ETag's path. That is, client compares the conversion tracking ID included in the snippet on advertiser's post conversion page with the conversion tracking ID associated with the ETag received at act. When the conversion tracking IDs match, client transmits the ETag, along with the post conversion image request, to server. It should be understood that client may receive a number of ETags from server when client performs ad clicks associated with various conversion tracking enabled advertisers in a manner similar to that discussed above with respect to advertiser. Therefore, client may compare the conversion tracking ID in the post conversion snippet with the conversion tracking IDs included in the ETag path for each of the ETags stored on client. When the conversion tracking ID in the snippet matches any one of the conversion tracking IDs in an ETag path of a stored ETag, the client will send that ETag to server. In some implementations consistent with the present invention, client may also examine the TS, if a TS is included in the ETag, to determine whether to send the ETag to server. For example, if client determines that the ETag has expired, client may not send the ETag. Server, however, may also look at the TS, as described below.

Assuming that the conversion tracking ID in the snippet matches the ETag associated with advertiser (and optionally, the TS indicates that the ETag has not expired), client sends the ETag for advertiser and the post conversion image request to server. When server receives the image request, conversion tracker examines the request and determines whether the conversion resulted from a paid advertisement. For example, server may look to see whether the ETag with the unique conversion tracking ID associated with advertiser has been received with the image request. The ETag may also include the CS as part of the ETag payload and the CS may identify the particular ad click(s) and/or action(s) performed by client. The ETag may also contain other data that may be used to correlate the click event with the conversion, e.g., when the click happened, the ad that was clicked on, etc.

If conversion tracker does not find such an ETag included with the image request, front end may determine that the conversion did not result from a paid advertisement. If front end has received such an ETag with the image request, front end may determine whether the ETag has expired based on the expiration date or TS information included with the ETag. Server may store information associated with the conversion, such as the value, type, etc. Front end may also return an image to client that states, for example, “Thank you for shopping at a Contextweb advertiser.” Client may then paste this image into the post conversion page displayed on client. Providing this image in the post conversion page allows clients to be aware that some of their actions are being tracked. If front end determines that the conversion did not result from a paid ad or that the ETag associated with the paid ad had expired, server may not store the conversion information. Server may also return a blank image or no image and client will not receive any additional message on the post conversion page.

Front end may also log the received image request into a log, such as a binary formatted log. Front end may further send a message to ad mixer indicating that the conversion occurred. Ad mixer may also log the conversion event in an ad conversion log. The ad conversion log may include records, such as, a number of conversion events, a value associated with each conversion event, a label associated with each conversion event, a time associated with each conversion event, the search engine or ad network associated with each conversion event, etc. Log processing module may access the ad conversion log and use the ad conversion data to populate a conversion events database. Log processing module may then generate reports based on information in the conversion events database.

For example, log processing module may generate a conversion ratio for a particular advertiser, such as advertiser. The conversion ratio may be based on the number of times a displayed ad associated with an advertiser was clicked at least once divided by the number of conversions that resulted from the ad. By generating the conversion ratio, both advertisers and search engine providers may determine the effectiveness of the paid ads.

More detailed analysis of advertisements can also be made. For example, log processing module may determine a total value of all conversions over a period of time for a particular advertiser that resulted from ads, a value per click, etc. Log processing module may also determine a conversion ratio based on where the ad is displayed. That is, server may store information indicating whether the paid ad was displayed at the top of a web page, as opposed to another location, such as the side of the web page, or the position of the ad in a ranked list. Log processing module may then analyze a conversion ratio with respect to the location of the displayed ad.

In another implementation consistent with the principles of the invention, a method that may include frequency capping of ad creative units. Information on how many times individual users have seen a creative unit can be stored and retrieved from the ETag and thereby limit overexposing users to the same unit avoiding creative burnout.

In another implementation consistent with the principles of the invention, a method that may include the sequencing of ad creative units. Information on which ads in a creative unit sequence can be stored in the ETag allow advertisers to select a sequencing of offers to the user based upon what the user has already seen.

In another implementation consistent with the principles of the invention, a method that may include expanding unique user reach of the advertiser. By tracking who has already seen creative units in the ETag, another implementation consistent with the principles of the invention can create unique exposure opportunities by not showing the creative units to those users who have already been exposed to it. This can be across the entire Internet space and not just within a single advertising network by distributing the ETag technology principles of the invention along with the creative unit so that exposures are tracked everywhere that the ad runs.

In another implementation consistent with the principles of the invention, a method that may include ecommerce shopping carts. The ETag can be utilized in ecommerce shopping cart situations where cookies are not available so that items in the users shopping cart are persisted from session to session. Again without size or number limitations inherent in cookie technology.

In another implementation consistent with the principles of the invention, a method that may include personalized messaging for returning users to publisher site or site section tailored to previous user actions.

In another implementation consistent with the principles of the invention, a method that may include unlimited number of ETags not restricted to browser cookie limits.

In another implementation consistent with the principles of the invention, a method that may include unlimited size of ETags not restricted to browser cookie limits.

As for the hardware and operating environment that may be used for implementing the methods of the present invention, various computing devices capable of supporting a browser are appropriate, including, but not limited to: a personal digital assistant (PDA), a mobile telephone, a notebook computer, a desktop computer, and the like. The most general purpose computing device is provided in the form of a computer that may, for example, be used as a workstation for executing a browser program or as a server for executing software for an advertiser or adserver. The computer includes a processing unit, a system memory, and a system bus that operatively couples various system components including the system memory to the processing unit. There may be only one or there may be more than one primary processing unit such that the processor of computer comprises a single central-processing unit (CPU), or a plurality of processing units, commonly referred to as a parallel processing environment. The computer may be a conventional computer, a distributed computer, or any other type of computer; the invention is not so limited. In the illustrated example, an auxiliary processor is also coupled to the system bus to provide processing operation for an auxiliary processing state. In an alternative implementation, the primary processing unit provides both a primary processing mode and an auxiliary processing mode.

The system bus may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) and random access memory (RAM). A basic input/output system (BIOS), containing the basic routines that help to transfer information between elements within the computer, such as during start-up, is stored in ROM. The computer further includes a hard disk drive for reading from and writing to a hard disk, not shown, a magnetic disk drive for reading from or writing to a removable magnetic disk, and an optical disk drive for reading from or writing to a removable optical disk such as a CD ROM or other optical media.

The hard disk drive, magnetic disk drive, and optical disk drive are connected to the system bus by a hard disk drive interface, a magnetic disk drive interface, and an optical disk drive interface, respectively. The drives and their associated computer-readable media provide nonvolatile storage of computer-readable instructions, data structures, program modules and other data for the computer. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk, optical disk, ROM, or RAM, including an operating system, one or more application programs, other program modules, and program data. A user may enter commands and information into the personal computer through input devices such as a keyboard and pointing device. Other input devices (not shown) may include a microphone, joystick, game pad, satellite dish, scanner, or the like. These and other input devices are often connected to the processing unit through a serial port interface that is coupled to the system bus, but may be connected by other interfaces, such as a parallel port, game port, or a universal serial bus (USB). A primary display device, such as a flat panel display or other type of display device, is also connected to the system bus via a display controller, such as a primary display adapter or an auxiliary display adapter. In the illustrated example, a multiplexer switches display signals from the individual display controllers. Alternatively, the display controllers can include components to provide high impedance, such as tri-state buffers, when not signaling the primary display adapter. In an alternative implementation, a single display controller may be employed via the primary processing unit. In addition to the primary display device, computers typically include other peripheral output devices (not shown), such as speakers and printers.

The computer may operate in a networked environment using logical connections to one or more remote computers, such as remote computer. These logical connections are achieved by a communication device coupled to or a part of the computer; the invention is not limited to a particular type of communications device. The remote computer may be another computer, a server, a router, a network PC, a client, a peer device or other common network node, and typically includes many or all of the elements described above relative to the computer. The logical connections include a local-area network (LAN) and a wide-area network (WAN). Such networking environments are commonplace in office networks, enterprise-wide computer networks, intranets and the Internet, which are all types of networks.

When used in a LAN-networking environment, the computer is connected to the local network through a network interface or adapter, which is one type of communications device. When used in a WAN-networking environment, the computer typically includes a modem, a network adapter, a type of communications device, or any other type of communications device for establishing communications over the wide area network. The modem, which may be internal or external, is connected to the system bus via the serial port interface. In a networked environment, program modules depicted relative to the personal computer, or portions thereof, may be stored in the remote memory storage device. It is appreciated that the network connections shown are example and other means of and communications devices for establishing a communications link between the computers may be used.

In an example implementation, an operating system, auxiliary applications, primary applications such as a browser, advertiser module, adserver module, or publisher module, and other modules may be embodied by instructions stored in memory and/or storage devices or and processed by the processing unit. Auxiliary processing settings, primary processing settings, and other data may be stored in memory and/or storage devices or as persistent datastores.

The technology described herein is preferably implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. Use of absolute terms, such as “will not,” “will,” “shall,” “shall not,” “must,” and “must not,” are not meant to limit the present invention as the embodiments disclosed herein are merely exemplary. Accordingly, the invention is to be limited only by the scope of the claims and their equivalents.

What we claim is:

1. A method for tracking user actions, comprising: identifying a user action; generating an ETag in response to the user action, the ETag being associated with an advertiser; transmitting the ETag to the user; and receiving the ETag from the user in response to another action by the user.

2. The method of claim 1, further comprising: generating a conversion ratio for the advertiser based at least in part on a number of conversions associated with the advertiser, each conversion being associated with at least one of a purchase activity, a registration activity, a sign-up activity, a page view activity and a download activity.

3. The method of claim 2, wherein the generating a conversion ratio includes:
determining a number of times an advertisement associated with the advertiser has been displayed or selected, determining a number of conversions resulting from the displayed advertisement, and generating a conversion ratio based on the number of times the advertisement was displayed or selected and the number of conversions.

4. A system comprising:
a server connected to a distributed computer network for detecting user actions, a means for generating an ETag in response to a user action associated with an advertisement provided to the user; and a means for determining that a conversion resulted from the advertisement.

5. A method for tracking user actions, comprising: providing an ad to a user; receiving an ad click associated with the ad; generating a ETag in response to the ad click; transmitting the ETag to the user; receiving information in response to a user action, the information indicating that the user performed a conversion associated with an advertiser; and determining whether the conversion resulted from the ad.

6. A method, comprising: selecting an ad associated with an advertiser; receiving a ETag in response to the selection; performing a conversion associated with the advertiser; determining whether an identifier associated with the ETag matches an identifier on a web page associated with the conversion; and transmitting the ETag when the identifiers match.
